(19) United States
(12) Patent Application Publication
(10) Pub. No.: US 2025/0113258 A1
(43) Pub. Date: Apr. 3, 2025

(54) DETERMINATION OF COMPATIBLE RESOURCE CONFIGURATIONS IN INTEGRATED ACCESS AND BACKHAUL MIGRATION AND TOPOLOGICAL REDUNDANCY

(71) Applicant: Telefonaktiebolaget LM Ericsson (publ), Stockholm (SE)

(72) Inventors: Boris DORTSCHY, Vendelsö (SE); Filip BARAC, Huddinge (SE); Magnus ÅSTRÖM, Lund (SE); Ritesh SHREEVASTAV, Upplands Väsby (SE); Lei BAO, Göteborg (SE)

(21) Appl. No.: 18/291,033

(22) PCT Filed: Aug. 5, 2022
(86) PCT No.: PCT/IB2022/057292

§ 371 Date: Jan. 22, 2024

Related U.S. Application Data
(60) Provisional application No. 63/230,582, filed on Aug. 6, 2021.

(51) Int. Cl. H04W 28/26; H04W 88/08

(52) U.S. Cl. CPC H04W 28/26; H04W 88/085

(57) ABSTRACT

A method, system and apparatus for determination of compatible resource configurations in integrated access and backhaul (IAB) migration and topological redundancy are disclosed. According to one aspect, a method in a first IAB donor node (16-2) includes receiving a first resource configuration for the first parent IAB node (16-4) from a second IAB donor node (16-1), the first parent IAB node (16-3) being in communication with a child IAB node (16-5). The method includes determining compatibility between the first resource configuration and a second resource configuration for a second parent IAB node (16-4). The method also includes determining whether to accept a request to establish a connection between the second parent IAB node (16-4) and the child IAB node (16-5) based at least in part on the compatibility determination.

### TECHNICAL FIELD

The present disclosure relates to wireless communications, and in particular, to determination of compatible resource configurations in integrated access and backhaul (IAB) migration and topological redundancy.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

### Integrated Access and Backhaul Overview

Densification via the deployment of increasing numbers of base stations (including macro or micro base stations) is one of the mechanisms that can be employed to satisfy the ever-increasing demand for greater bandwidth and capacity in mobile networks. Due to the availability of more spectrum in the millimeter wave (mmw) band, deploying small cells that operate in this band is an attractive deployment option for increasing bandwidth and coverage. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

FIG. 1 is a diagram showing an example an IAB deployment that supports multiple hops. The IAB-donor has a wired connection to the core network and the IAB-nodes are wirelessly connected using NR to the IAB-donor, either directly or indirectly via another IAB-node. The connection between an IAB-donor node and WDs is called an access link, whereas the connection between two IAB-nodes or between an IAB-donor and an IAB-node is called a backhaul link.

Further, as shown in the example of FIG. 2, the adjacent upstream node which is closer to the IAB-donor of an IAB-node is referred to as a parent node of the IAB-node. The adjacent downstream node which is further away from the IAB-donor of an IAB-node is referred to as a child node of the IAB-node. The backhaul link between the parent node and the IAB-node is referred to as parent (backhaul) link, whereas the backhaul link between the IAB-node and the child node is referred to as child (backhaul) link.

### IAB Architecture

A difference between the IAB architecture shown in FIG. 2 to a 3GPP Release 10 (3GPP Rel-10)-compatible LTE relay (besides lower layer differences) is that the IAB architecture adopts the Central-Unit/Distributed-Unit (CU/DU) split of gNBs (New Radio base stations) in which time-critical functionalities are realized in the IAB-DU closer to the radio, whereas the less time-critical functionalities are pooled in the CU with the opportunity for centralization. Based on this architecture, an IAB-donor contains both CU and DU functions. In particular, the IAB-donor contains all CU functions of the IAB-nodes under the same IAB-donor. Each IAB-node then hosts the DU function(s) of a gNB. In order to be able to transmit and/or receive wireless signals to and from the upstream IAB-node or IAB-donor, each IAB-node has a mobile termination (MT), a logical unit providing a necessary set of WD-like functions. Via the IAB-DU, the IAB-node establishes a radio link control (RLC) channel to WDs and/or to MTs of the connected IAB-node(s). Via the IAB-MT, the IAB-node establishes the backhaul radio interface towards the serving IAB-node or IAB-donor. FIG. 3 shows an example reference diagram for a two-hop chain of IAB-nodes under an IAB-donor.

### IAB Topologies

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the 3GPP Rel-10 LTE relay.

The following topologies are considered in IAB as shown in the example diagram of FIG. 4:
Spanning tree (ST); and
Directed acyclic graph (DAG).

In these topologies, one IAB-node can have multiple child nodes and/or have multiple parent IAB-nodes. Particularly regarding multi-parent topology, different scenarios may be considered as shown in the example of FIG. 5. For example:
IAB-9 connects to IAB-donor 1 via two parent nodes IAB-5 and IAB-6 which connect to the same grandparent node IAB-1;
IAB-10 connects to IAB-donor 1 via two parent nodes IAB-6 and IAB-7 which connect to different grandparent nodes IAB-1 and IAB-2; and
IAB-8 connects to two parent nodes IAB-3 and IAB-4 which connect to different IAB-donors IAB-donor 1 and IAB-donor 2.

The multi-connectivity or route redundancy may be used for back-up purposes. It is also possible that redundant routes are used concurrently, e.g., to achieve load balancing, reliability, etc.

According to the 3GPP IAB Technical Release (TR) 38.874 [1], when operating in standalone (SA)-mode, an NR+NR dual-connected IAB-node can add redundant routes by establishing an MCG-link (master cell group) to one parent node IAB-DU and an SCG-link (secondary cell group) to another parent node IAB-DU. The dual-connecting IAB-MT will enable the SCG link using the 3GPP Rel-15 NR-DC (dual connectivity) procedures.

### Inter-Donor Topological Redundancy

RAN3 has considered the following two scenarios for the inter-donor topology redundancy, shown in the example of FIGS. 6 and 7:
Scenario 1: the IAB is multi-connected with 2 IAB-donors (FIG. 6);
Scenario 2: the IAB's parent/ancestor node is multi-connected with 2 IAB-donors (FIG. 7).

### Resource Coordination

In case of in-band operation, the IAB-node is typically subject to the half-duplex constraint, i.e., an IAB-node can only be in either a transmission mode or a reception mode at a time. 3GPP Rel-16 IAB mainly considers the time-division multiplexing (TDM) case where the IAB-MT and IAB-DU resources of the same IAB-node are separated in time. Based on this consideration, the following resource types have been defined for IAB-MT and IAB-DU, respectively.

From an IAB-MT point-of-view, as in 3GPP Rel-15, the following time-domain resources can be indicated for the parent link:
Downlink (DL) time resource;
Uplink (UL) time resource; and
Flexible (FL) time resource.

From an IAB-DU point-of-view, the child link has the following types of time resources:
DL time resource;
UL time resource;
FL time resource; and
Not-available (NA) time resources (resources not to be used for communication on the DU child links).

There are three example ways to provide the DL/UL/FL configurations as follows:
Semi static configuration: configured by TDD-UL-DL-ConfigurationCommon, or TDD-UL-DL-ConfiguDedicated;
RRC configuration: corresponding to a higher-layer configured DL symbols by for example PDCCH, PDSCH, channel state information reference signal (CSI-RS), etc., or UL symbols by for example sounding reference signal (SRS), PUCCH, PUSCH, PRACH; and
Dynamic: configured by downlink control information (DCI) formats.

Each of the downlink, uplink and flexible time-resource types of the DU child link can belong to one of two categories:
Hard (H): The corresponding time resource is always available for the DU child link; and
Soft(S): The availability of the corresponding time resource for the DU child link is explicitly and/or implicitly controlled by the parent IAB-node.

The IAB-DU resources are configured per cell, and the H/S/NA attributes for the IAB-DU resource configuration are explicitly indicated per-resource type (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (FL-H), Flexible-Soft (FL-S), and Not-Available (NA). The coordination relation between IAB-MT and IAB-DU resources are listed in Table 1 below.

TABLE 1

| | | IAB-MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL |
| | | | | & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL |
| | | | | & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on DL. | MT: available on UL. | MT: available on DL |
| | | | | & UL. |
| | NA | DU: not available; | DU: not available; | DU: not available; |
| | | MT: available on DL. | MT: available on UL. | MT: available on DL |
| | | | | & UL. |

Furthermore, a DU function may correspond to multiple cells, including cells operating on different carrier frequencies. Similarly, an MT function may correspond to multiple carrier frequencies. This can either be implemented by one MT unit operating on multiple carrier frequencies, or be implemented by multiple MT units, each operating on one carrier frequency. The H/S/NA attributes for the per-cell DU resource configuration should take into account the associated MT carrier frequency (or frequencies).

Two examples of ways to indicate the availability from the parent IAB-node include: implicit indication and explicit indication. In case of implicit indication, the IAB-node knows, via indirect means, such as lack of scheduling grant, no data available at the MT, the IAB-node being capable of simultaneous DU and MT, etc., that the DU resource can be used without impacting the MT's ability to transmit or receive. In addition to such implicit means, the IAB-node may also receive explicit indication from the parent IAB-node about the availability.

RAN3 has considered two scenarios, shown in the examples of FIGS. 8 and 9. In a first scenario, an IAB-MT (MT3 in FIG. 8) is migrating to a parent IAB-node under a different IAB-donor-CU. Meanwhile, the IAB-DU of the migrating IAB-node (DU3 in FIG. 8) remains connected to the same CU as before (CU1 in FIG. 8). In a second scenario, an IAB-MT (MT3 in FIG. 9) is connecting using dual-connectivity (DC) to a second parent IAB-node (IAB-node 2 in FIG. 9) under a different IAB-donor-CU (CU2 in FIG. 9). In this context, the IAB-node 3 in FIG. 9 is referred to as the boundary IAB-node-per definition, the IAB-DU of a boundary node being terminated to a different IAB-donor-CU than one of its parent IAB-DU.

In either scenario, it is not clear how the use of resources between the IAB-node's child link and the parent link(s) should be coordinated. For example, the resource coordination could be with respect to the following configuration parameters:
TDD pattern (Downlink/Uplink/Flexible) alignment between the parent links;
H/S/NA resource configuration of IAB-DU(s) and the parent IAB-DU(s); and
Explicit indication of IAB-DU soft resource.

In cases of TDD pattern alignment, for example in the intra-band inter-carrier DC case, if the two carriers of the MCG and SCG links are located too close in frequency for the IAB-MT to operate on them independently, the IAB-MT is not able to support asynchronous TDD patterns, i.e., the multiple serving cells of MCG and SCG links should not have different DL/UL transmission direction.

Normally, it is assumed that after successful IAB migration, or establishment of dual connectivity, the IAB-donor-CU(s) should solve the conflict of semi-static resource configurations (e.g., D/U/F and H/S/NA resource configurations) between the new parent and the migrating child IAB-node, or between a boundary IAB-node and the second parent-node in the DC scenario. In addition, with respect to the Scenario 2 (FIG. 9), it is assumed that the parent IAB-node can be made aware of not only its own semi-static configurations, but also of the semi-static configurations of the peer parent IAB-node, and the dual-connected IAB-node—this is because the conflict between these three configurations should be avoided.

On the other hand, how to ensure compatibility between resources of the two parent nodes before migration and during dual-connectivity is not specified. For scenarios 1 and 2 of FIGS. 8 and 9, RAN3 considers the following solutions (other solutions are not precluded) for resource coordination between the parent link and the child link:
Option 1A: The child node's gNB-DU cell resource configuration is matched to the parent node's gNB-DU's resource configuration;
Option 2A: The parent node's gNB-DU resource configuration is matched to the child node's gNB-DU's resource configuration; and/or.
Option 3A: A boundary node should connect only to a new parent with which it has a non-conflicting TDD and H/S/NA pattern beforehand.

For Scenario 2 (FIG. 9), RAN3 considers the following solutions (other solutions are not precluded) for the coordination between two parent links:
Option 1B: The gNB-DU cell resource configuration of the parent node controlled by the F1-terminating donor of the boundary node, is matched to another parent's gNB-DU's resource configuration;
Option 2B: The gNB-DU cell resource configuration of the parent node controlled by the non-F1-terminating donor of the boundary node, is matched to another parent's gNB-DU's resource configuration; and/or
Option 3B: The secondary leg of a boundary node is established only towards a secondary parent whose H/S/NA configuration is compatible with the H/S/NA configuration of the master parent beforehand.

In both cases (scenarios 1 and 2 of FIGS. 8 and 9), how to determine compatible resource configurations described in Option 3B is not further elaborated. It should be noted that requiring the two configurations to be identical might be too strict, which may greatly limit the network performance. To enable IAB migration and dual connectivity (DC) in the two scenarios, e.g., to achieve load balancing, reliability, etc., alternative methods to determine compatible resource configurations is needed.

One major difference between regular WDs and IAB-nodes is that IAB-nodes may serve a number of other IAB-nodes and WDs, where the IAB-node must have compatible resource configurations with its served IAB nodes. This means that the issue of resource compatibility between two legs of a dual connected IAB-node may be more important than is the case for normal dual-connected WDs.

### SUMMARY

Some embodiments advantageously provide methods, systems, and apparatuses for determination of compatible resource configurations in integrated access and backhaul (IAB) migration and topological redundancy.

In some embodiments, when migrating to a second parent IAB-node, or when establishing dual connectivity, where one leg is towards a parent under another IAB-donor-CU, the network function unit may evaluate and determine the compatibility of resource configurations considering the following non-limiting examples:
In cases of IAB-node migration, the compatibility of resource configurations between the potential new parent IAB-node and the migrating IAB-node; and
For a dual-connected IAB-node, the compatibility of resource configurations between two parent links, in addition to the compatibility of resource configurations between the new second parent IAB-node and the IAB-node to be dual-connected.

Based on the evaluation result, the network function unit can coordinate the resources at the associated parent IAB-nodes accordingly, to achieve compatible configurations without providing new semi-static resource configurations to both parent-nodes.

A prioritization order may be defined for the associated parent IAB-nodes when competing for certain resources. Alternatively, a compatible resource configuration set is defined and provided to the two parent IAB-nodes. When the migration/DC request is approved, each associated parent IAB-node may be provided with the resource configuration of the other parent IAB-node(s), which serves the same IAB-node.

Some embodiments address at least one or both of the following two scenarios:
Inter-donor migration of a single-connected IAB-node; and/or
Establishment of inter-donor dual connectivity for an IAB-node.

When an IAB-node performs migration/DC to a new parent IAB-node, some embodiments provide resource coordination methods to enable:
for a migrating IAB-node, compatible resource configurations between the new parent node and the migrating IAB-node; and/or,
for a dual-connected IAB-node, compatible resource configurations between the two parent IAB-nodes, without a reconfiguration of the semi-static resource for both parent nodes and the dual-connected IAB-node.

Ensuring resource configuration compatibility ensures that massive reconfigurations of the nodes involved in migration and DC establishment (i.e., migrating nodes and their parents and served node or DC nodes and their parents and served nodes) can be avoided.

According to one aspect, a first integrated access and backhaul, IAB, donor node. The first IAB donor node includes processing circuitry configured to: receive a first resource configuration for a first parent IAB node from a second IAB donor node, the first parent IAB node being in communication with an child IAB node; determine compatibility between the first resource configuration and a second resource configuration for a second parent IAB node; and determine whether to accept a request to establish a connection between the second parent IAB node and the child IAB node based at least in part on the compatibility determination.

According to this aspect, in some embodiments, when it is determined that there is a compatibility between the first and second resource configurations, the processing circuitry is further configured to configure the second parent IAB node with the second resource configuration. In some embodiments, when it is determined that there is a compatibility between the first and second resource configurations, the processing circuitry is further configured to send the second resource configuration to the second IAB donor node. In some embodiments, determining compatibility between the first and second resource configurations is based at least in part on a ratio of an amount of conflicting resources to an amount of compatible resources between the first and second resource configurations. In some embodiments, the processing circuitry is further configured to determine conflicting resources between the first and second resource configurations and to deactivate the conflicting resources for at least one of the first parent IAB node and the second parent IAB node. In some embodiments, determining compatibility between the first and second resource configurations is based at least in part on a priority associated with each of the first and second parent IAB nodes. In some embodiments, the processing circuitry is further configured to determine whether to accept the request to establish the connection based at least in part on an amount of congestion in one of the first and second parent IAB nodes.

According to another aspect, a method in a first IAB donor node is provided. The method includes: receiving a first resource configuration for the first parent IAB node from a second IAB donor node, the first parent IAB node being in communication with an child IAB node; determining compatibility between the first resource configuration and a second resource configuration for a second parent IAB node; and determining whether to accept a request to establish a connection between the second parent IAB node and the child IAB node based at least in part on the compatibility determination.

According to this aspect, in some embodiments, the method includes, when it is determined that there is a compatibility between the first and second resource configurations, configuring the second parent IAB node with the second resource configuration. In some embodiments, the method includes when it is determined that there is a compatibility between the first and second resource configurations, sending the second resource configuration to the second IAB donor node. In some embodiments, determining compatibility between the first and second resource configurations is based at least in part on a ratio of an amount of conflicting resources to an amount of compatible resources between the first and second resource configurations. In some embodiments, the method includes determining conflicting resources between the first and second resource configurations and to deactivate the conflicting resources for at least one of the first parent IAB node and the second parent IAB node. In some embodiments, determining compatibility between the first and second resource configurations is based at least in part on a priority associated with each of the first and second parent IAB nodes. In some embodiments, the method includes determining whether to accept the request to establish the connection based at least in part on an amount of congestion in one of the first and second parent IAB nodes.

According to yet another aspect, a first integrated access and backhaul, IAB, donor node. The first IAB donor node includes processing circuitry configured to: send to a second IAB donor node a request to establish a connection between the child IAB node and a second parent IAB node, the child IAB node being in communication with a first parent IAB node; send a first resource configuration of the first parent IAB node to the second IAB donor node; and receive a second resource configuration of the second parent IAB node from the second IAB donor node, the second resource configuration based at least in part on a determination of compatibility between the first resource configuration and a second resource configuration for the second parent IAB node.

According to this aspect, in some embodiments, the processing circuitry is further configured to send a second resource configuration of the first parent IAB node to the first parent IAB node, the second resource configuration based at least in part on the determination of compatibility. In some embodiments, the processing circuitry is further configured to receive the second resource configuration of the first parent IAB node. In some embodiments, the second resource configuration includes an indication of conflicting resources to be deactivated by the first IAB donor node. In some embodiments, the processing circuitry is further configured to perform the determination of compatibility between the first resource configuration and the second resource configuration.

According to yet another aspect, a method in a first IAB donor node is provided. The method includes sending to a second IAB donor node a request to establish a connection between the child IAB node and a second parent IAB node; sending a first resource configuration of a first parent IAB node to the second IAB donor node; and receiving a second resource configuration of the second parent IAB node from the second IAB donor node, the second resource configuration based at least in part on a determination of compatibility between the first resource configuration and a second resource configuration for the second parent IAB node.

According to this aspect, in some embodiments, the method includes sending a second resource configuration of the first parent IAB node to the first parent IAB node, the second resource configuration based at least in part on the determination of compatibility. In some embodiments, the method includes receiving the second resource configuration of the first parent IAB node. In some embodiments, the second resource configuration includes an indication of conflicting resources to be deactivated by the network node. In some embodiments, the method also includes performing the determination of compatibility between the first resource configuration and the second resource configuration.

According to another aspect, a first parent IAB node includes processing circuitry configured to: receive a first resource configuration from a first IAB donor node, the first resource configuration being based at least in part on a determination of compatibility between the first resource configuration and a second resource configuration for a second parent IAB node in communication with an child IAB node; and establish a connection between the first parent IAB node and the child IAB node according to the first resource configuration.

According to this aspect, in some embodiments, a second IAB donor node is in communication with the first IAB donor node. In some embodiments, the processing circuitry is further configured to maintain a master cell group link, the second parent IAB node being configured to maintain a secondary cell group link. In some embodiments, the processing circuitry is further configured to indicate one of a downlink direction and an uplink direction to the child IAB node based at least in part on the first resource configuration. In some embodiments, the processing circuitry is further configured to deactivate resources deemed to be conflicting with the second resource configuration of the second parent IAB node.

According to another aspect, a method in a first parent IAB node is provided, The method includes receiving a first resource configuration from the first IAB donor node, the first resource configuration being based at least in part on a determination of compatibility between the first resource configuration and a second resource configuration for a second parent IAB node in communication with an child IAB node; and establishing a connection between the first parent IAB node and the child IAB node according to the first resource configuration.

According to this aspect, in some embodiments, a second IAB donor node is in communication with the first IAB donor node. In some embodiments, the method includes maintaining a secondary cell group link, the second parent IAB node being configured to maintain a master cell group link. In some embodiments, the method includes indicating one of a downlink direction and an uplink direction to the child IAB node based at least in part on the first resource configuration. In some embodiments, the method includes deactivating resources deemed to be conflicting with the second resource configuration of the second parent IAB node.

According to another aspect, a first parent IAB node includes processing circuitry configured to: receive a first resource configuration from the first IAB donor node, the first resource configuration being based at least in part on a determination of compatibility between the first resource configuration and a second resource configuration for a second parent IAB node in communication with an child IAB node; and configure resources of the first parent IAB node according to the first resource configuration.

According to this aspect, in some embodiments, a second IAB donor node is in communication with the first IAB donor node. In some embodiments, the processing circuitry is further configured to maintain a secondary cell group link, the second parent IAB node being configured to maintain a master cell group link. In some embodiments, the processing circuitry is further configured to indicate one of a downlink direction and an uplink direction to the child IAB node based at least in part on the first resource configuration. In some embodiments, the processing circuitry is further configured to deactivate resources deemed to be conflicting with the second resource configuration of the second parent IAB node.

According to another aspect, a method in a network node configured to operate as a first integrated access and backhaul, IAB, parent node is provided, the network node being in communication with a first IAB donor node. The method includes receiving a first resource configuration from the first IAB donor node, the first resource configuration being based at least in part on a determination of compatibility between the first resource configuration and a second resource configuration for a second parent IAB node in communication with an child IAB node; and configure resources of the first parent IAB node according to the first resource configuration.

According to this aspect, in some embodiments, a second IAB donor node is in communication with the first IAB donor node. In some embodiments, the method includes maintaining a secondary cell group link, the second parent IAB node being configured to maintain a master cell group link. In some embodiments, the method includes indicating one of a downlink direction and an uplink direction to the child IAB node based at least in part on the first resource configuration. In some embodiments, the method includes deactivating resources deemed to be conflicting with the second resource configuration of the second parent IAB node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates multi-hop deployment in an IAB network;

FIG. 2 illustrates IAB terminologies in adjacent hops in an IAB network;

FIG. 3 illustrates an example of an IAB architecture;

FIG. 4 illustrates two IAB topologies;

FIG. 5 illustrates IAB multi-parent scenarios;

FIG. 6 is a first scenario for inter-donor topological redundancy;

FIG. 7 is a second scenario for inter-donor topological redundancy;

FIG. 8 is a first scenario for IAB-node migration;

FIG. 9 is a second scenario for IAB-node migration;

FIG. 10 is a schematic diagram of an example network architecture illustrating a communication system connected via an intermediate network to a host computer according to the principles in the present disclosure;

FIG. 11 is a block diagram of a host computer communicating via a network node with a wireless device over an at least partially wireless connection according to some embodiments of the present disclosure;

FIG. 12 is a flowchart illustrating example methods implemented in a communication system including a host computer, a network node and a wireless device for executing a client application at a wireless device according to some embodiments of the present disclosure;

FIG. 13 is a flowchart illustrating example methods implemented in a communication system including a host computer, a network node and a wireless device for receiving user data at a wireless device according to some embodiments of the present disclosure;

FIG. 14 is a flowchart illustrating example methods implemented in a communication system including a host computer, a network node and a wireless device for receiving user data from the wireless device at a host computer according to some embodiments of the present disclosure;

FIG. 15 is a flowchart illustrating example methods implemented in a communication system including a host computer, a network node and a wireless device for receiving user data at a host computer according to some embodiments of the present disclosure;

FIG. 16 is a flowchart of an example process in a network node operating as a IAB-donor-CU for determination of compatible resource configuration in integrated access and backhaul (IAB) migration and topological redundancy;

FIG. 17 is a flowchart of an example process in a network node operating a parent IAB-node for determination of compatible resource configuration in integrated access and backhaul (IAB) migration and topological redundancy;

FIG. 18 is a flowchart of an example process in a network node operating a dual connectivity-capable child IAB-node for determination of compatible resource configuration in integrated access and backhaul (IAB) migration and topological redundancy;

FIG. 19 is a flowchart of an example process in a first IAB donor node according to principles disclosed herein;

FIG. 20 is a flowchart of an example process in a second IAB donor node according to principles disclosed herein;

FIG. 21 is a flowchart of an example process in an parent IAB node according to principles disclosed herein;

FIG. 22 is a flowchart of an example process in a second parent IAB node according to principles disclosed herein;

FIG. 23 illustrates a scenario for inter-donor topology redundancy according to principles set forth herein;

FIG. 24 illustrates a system overview according to principles set forth herein;

FIG. 25 is a flowchart of an example process for an inter-donor migration scenario;

FIG. 26 is a flowchart of an example of IAB integration;

FIG. 27 is an example of a configuration for resource compatibility between IAB nodes; and

FIG. 28 is an example of another configuration for resource compatibility between IAB nodes.

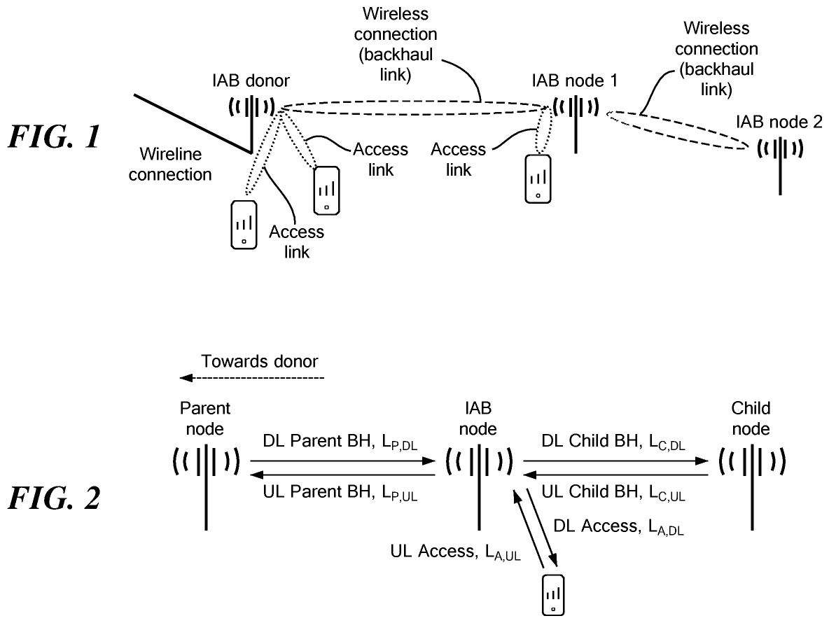

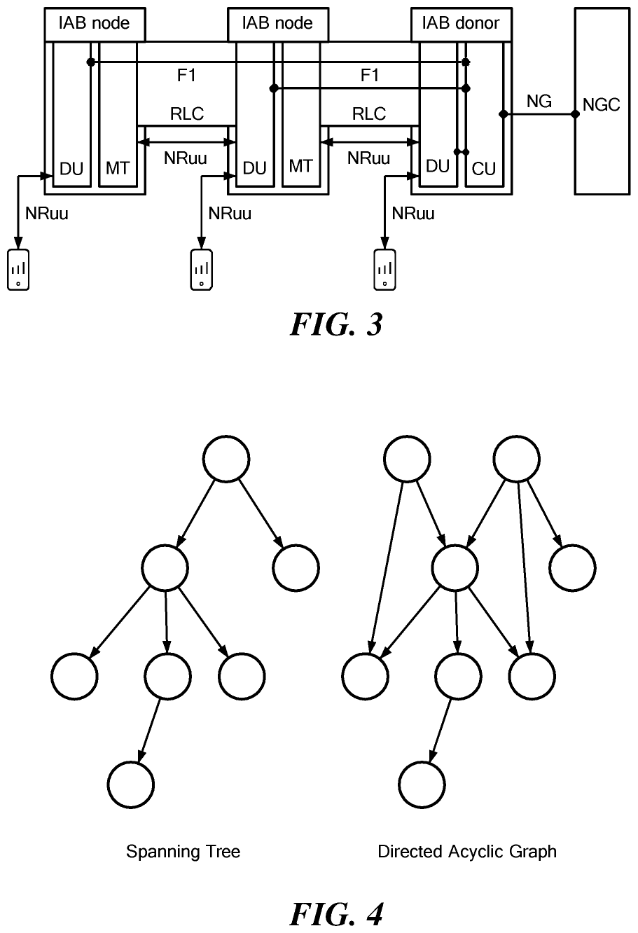

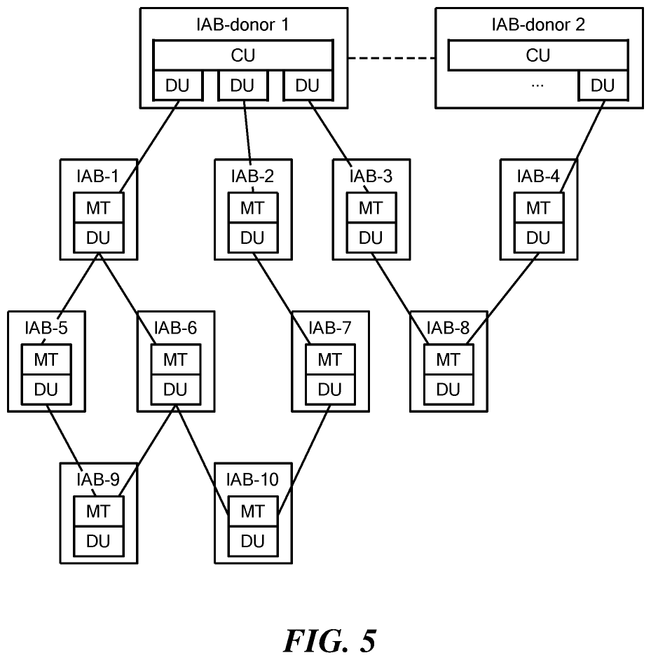

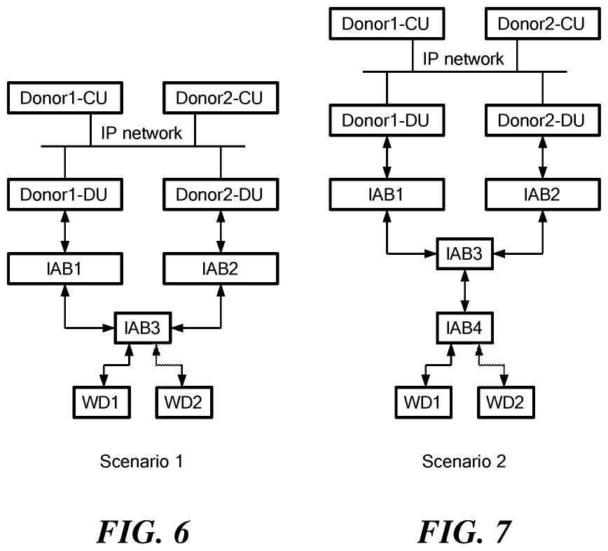

### DETAILED DESCRIPTION

Before describing in detail example embodiments, it is noted that the embodiments reside primarily in combinations of apparatus components and processing steps related to determination of compatible resource configuration in integrated access and backhaul (IAB) migration and topological redundancy. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for determination of compatible resource configuration in integrated access and backhaul (IAB) migration and topological redundancy.

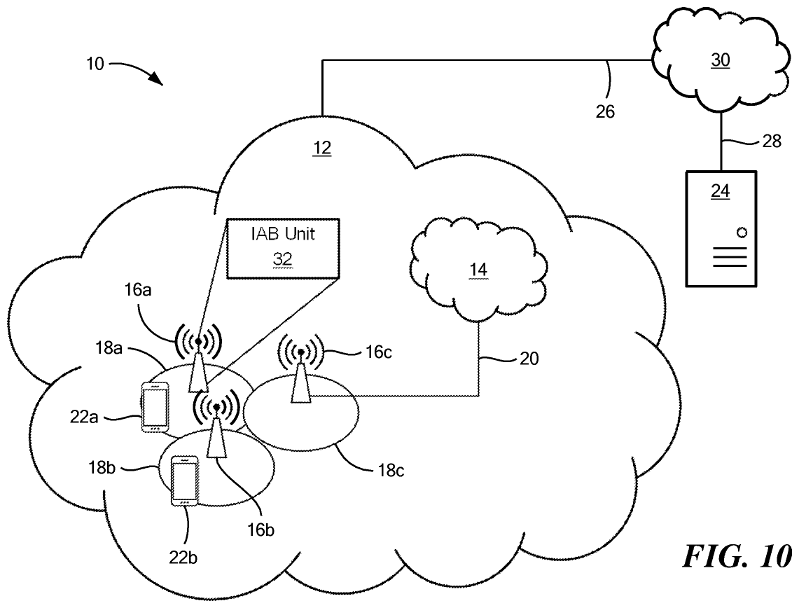

Referring again to the drawing figures, in which like elements are referred to by like reference numerals, there is shown in FIG. 10 a schematic diagram of a communication system 10, according to an example embodiment Communication system 10 may be, for example, a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. As explained in more detail below, the network nodes 16 may be configured to function as at least one of an IAB donor node, an parent IAB node and an child IAB node.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The host computer 24 may be configured to perform functions of at least one of an IAB donor node and an parent IAB node. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 10 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a IAB unit 32 which is configured to perform functions of an IAB-node. In some embodiments, the IAB unit 32 may be configured to implement the functions of any one or more of an IAB-donor-CU, a parent IAB-node and a child IAB-node, where the child IAB-node may be configured to have dual connectivity capability. When the network node 16 operates as an IAB-donor-CU, the IAB unit 32 may be configured to determine compatibility between the first resource configuration and a second resource configuration for a second parent IAB node. This IAB unit 32 may also be configured to evaluate a compatibility of a resource configuration of a first parent IAB-node with a resource configuration of a second parent IAB-node. The IAB unit 32 of an IAB-donor-CU may also be configured to send a first resource configuration of a first parent IAB node to a second IAB donor node. When the network node 16 operates as a parent IAB-node, the IAB unit 32 may be configured to establish a connection between the network node and the child IAB node according to the first resource configuration. The IAB unit may also be configured to obtain a resource configuration from the first IAB-donor-CU, the resource configuration being selected according to an evaluation of compatibility between resources of the network node and a DC-capable child IAB-node. When the network node 16 operates as a child IAB-node, the IAB unit 32 may be configured to receive a resource configuration from the IAB-donor-CU via the first parent IAB-node, the resource configuration being selected according to an evaluation of compatibility between resources of the network node and the first parent IAB-node.

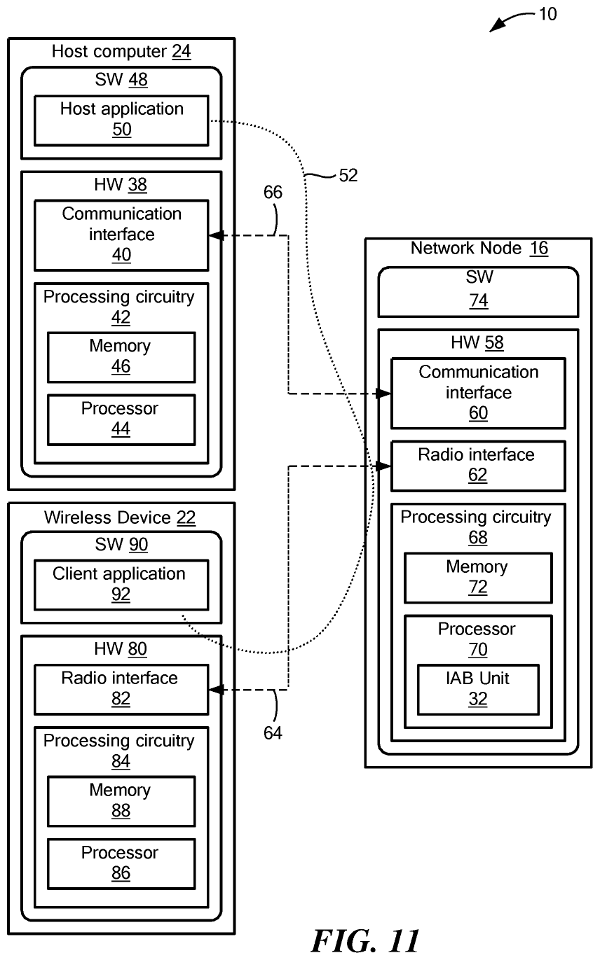

Example implementations, in accordance with an embodiment, of the WD 22, network node 16 and host computer 24 discussed in the preceding paragraphs will now be described with reference to FIG. 11. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10. In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an IAB unit 32 which is configured to perform functions of an IAB-node.

In some embodiments, the IAB unit 32 may be configured to implement the functions of any one or more of an IAB-donor-CU, a parent IAB-node and a child IAB-node, where the child IAB-node may be configured have dual connectivity capability. When the network node 16 operates as an IAB-donor-CU, the IAB unit 32 may be configured to determine compatibility between the first resource configuration and a second resource configuration for a second parent IAB node. This IAB unit 32 may also be configured to evaluate a compatibility of a resource configuration of a first parent IAB-node with a resource configuration of a second parent IAB-node. The IAB unit 32 of an IAB-donor-CU may also be configured to send a first resource configuration of a first parent IAB node to a second IAB donor node. When the network node 16 operates as a parent IAB-node, the IAB unit 32 may be configured to establish a connection between the network node and the child IAB node according to the first resource configuration. The IAB unit may also be configured to obtain a resource configuration from the first IAB-donor-CU, the resource configuration being selected according to an evaluation of compatibility between resources of the network node and a DC-capable child IAB-node. When the network node 16 operates as a child IAB-node, the IAB unit 32 may be configured to receive a resource configuration from the IAB-donor-CU via the first parent IAB-node, the resource configuration being selected according to an evaluation of compatibility between resources of the network node and the first parent IAB-node.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 11 and independently, the surrounding network topology may be that of FIG. 10.

In FIG. 11, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 10 and 11 show various “units” such as IAB unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

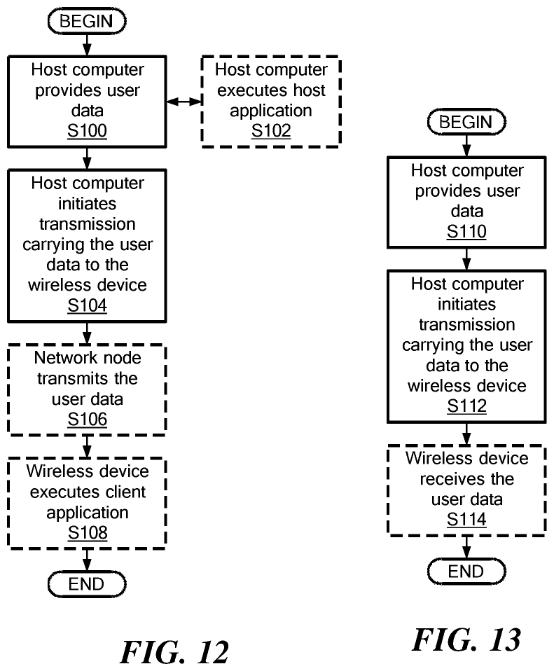

FIG. 12 is a flowchart illustrating an example method implemented in a communication system, such as, for example, the communication system of FIGS. 10 and 11, in accordance with one embodiment. The communication system may include a host computer 24, a network node 16 and a WD 22, which may be those described with reference to FIG. 11. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 13 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

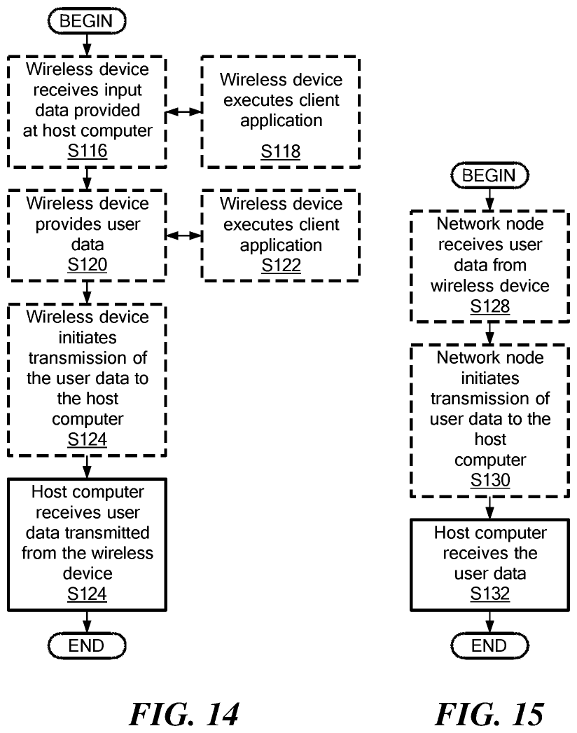

FIG. 14 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 15 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

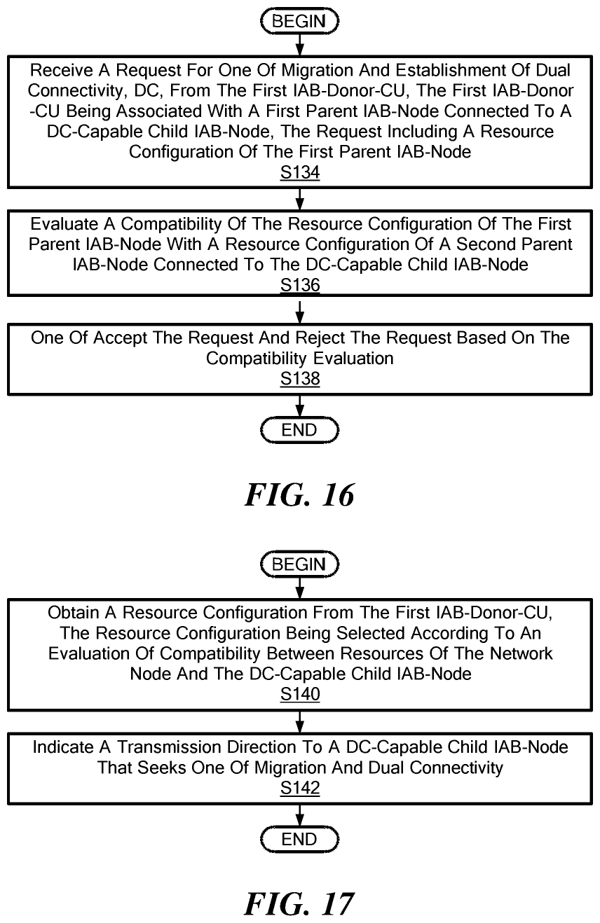

FIG. 16 is a flowchart of an example process in a network node 16 for determination of compatible resource configuration in integrated access and backhaul (IAB) migration and topological redundancy. One or more blocks described herein may be performed by one or more elements of network node 16 such as by one or more of processing circuitry 68 (including the IAB unit 32), processor 70, radio interface 62 and/or communication interface 60. Network node 16 such as via processing circuitry 68 and/or processor 70 and/or radio interface 62 and/or communication interface 60 is configured to receive a request for one of migration and establishment of dual connectivity, DC, from the first IAB-donor-CU, the first IAB-donor-CU being associated with a first parent IAB-node connected to a DC-capable child IAB-node, the request including a resource configuration of the first parent IAB-node (Block S134). The process also includes evaluating a compatibility of the resource configuration of the first parent IAB-node with a resource configuration of a second parent IAB-node connected to the DC-capable child IAB-node (Block S136). In some embodiments, evaluating a compatibility of the resource configuration of the first parent IAB node includes evaluating compatibility of the resource configuration of the first parent IAB node with a resource configuration of the DC-capable child IAB node. The process further includes one of accepting the request and rejecting the request based on the compatibility evaluation (Block S138).

FIG. 17 is a flowchart of an example process in a network node 16 for determination of compatible resource configuration in integrated access and backhaul (IAB) migration and topological redundancy. One or more blocks described herein may be performed by one or more elements of network node 16 such as by one or more of processing circuitry 68 (including the IAB unit 32), processor 70, radio interface 62 and/or communication interface 60. Network node 16 such as via processing circuitry 68 and/or processor 70 and/or radio interface 62 and/or communication interface 60 is configured to obtain a resource configuration from the first IAB-donor-CU, the resource configuration being selected according to an evaluation of compatibility between resources of the network node and the DC-capable child IAB-node (Block S140). The process also includes indicating a transmission direction to a child IAB-node that seeks one of migration and dual connectivity (Block S142).

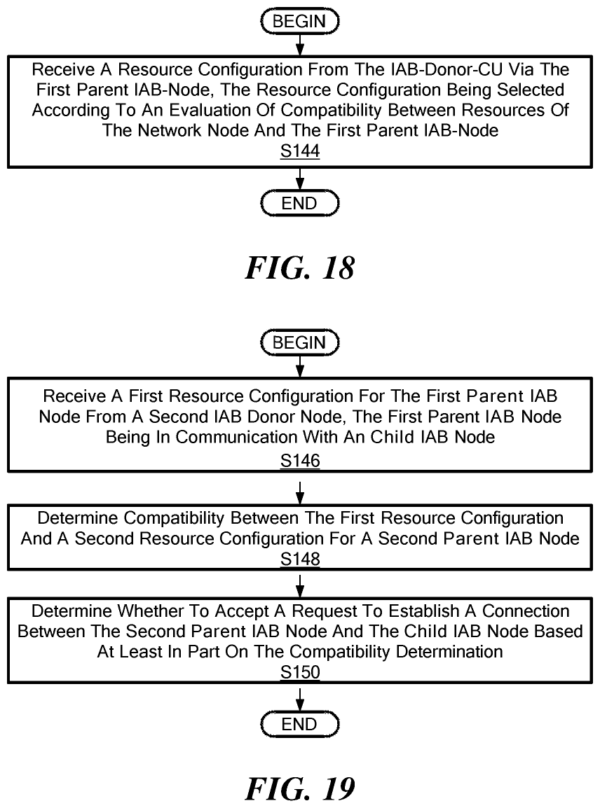

FIG. 18 is a flowchart of an example process in a network node 16 for determination of compatible resource configuration in integrated access and backhaul (IAB) migration and topological redundancy. One or more blocks described herein may be performed by one or more elements of network node 16 such as by one or more of processing circuitry 68 (including the IAB unit 32), processor 70, radio interface 62 and/or communication interface 60. Network node 16 such as via processing circuitry 68 and/or processor 70 and/or radio interface 62 and/or communication interface 60 is configured to receive a resource configuration from the IAB-donor-CU via the first parent IAB-node, the resource configuration being selected according to an evaluation of compatibility between resources of the network node and the first parent IAB-node (Block S144).

FIG. 19 is a flowchart of an example process in a first IAB donor node 16-2 acting as a non-F1 terminating donor node for determination of compatible resource configuration in integrated access and backhaul (IAB) migration and topological redundancy. One or more blocks described herein may be performed by one or more elements of first IAB donor node 16-2 such as by one or more of processing circuitry 68 (including the IAB unit 32), processor 70, radio interface 62 and/or communication interface 60. First IAB donor node 16-2 such as via processing circuitry 68 and/or processor 70 and/or radio interface 62 and/or communication interface 60 is configured to receive a first resource configuration for a first parent IAB node 16-3 from the second IAB donor node 16-1, the first parent IAB node 16-3 being in communication with an child IAB node 16-5 (Block S146); determine compatibility between the first resource configuration and a second resource configuration for a second parent IAB node 16-4 (Block S148); and determine whether to accept a request to establish a connection between the second parent IAB node 16-4 and the child IAB node 16-5 based at least in part on the compatibility determination (Block S150).

According to this aspect, in some embodiments, when it is determined that there is a compatibility between the first and second resource configurations, the processing circuitry is further configured to configure the second parent IAB node 16-4 with the second resource configuration. In some embodiments, when it is determined that there is a compatibility between the first and second resource configurations, the processing circuitry 68 is further configured to send the second resource configuration to the second IAB donor node 16-1. In some embodiments, determining compatibility between the first and second resource configurations is based at least in part on a ratio of an amount of conflicting resources to an amount of compatible resources between the first and second resource configurations. In some embodiments, the processing circuitry is further configured to determine conflicting resources between the first and second resource configurations and to deactivate the conflicting resources for at least one of the first parent IAB node 16-3 and the second parent IAB node 16-4. In some embodiments, determining compatibility between the first and second resource configurations is based at least in part on a priority associated with each of the first and second parent IAB nodes 16-3, 16-4. In some embodiments, the processing circuitry is further configured to determine whether to accept the request to establish the connection based at least in part on an amount of congestion in one of the first and second parent IAB nodes 16-3, 16-4.

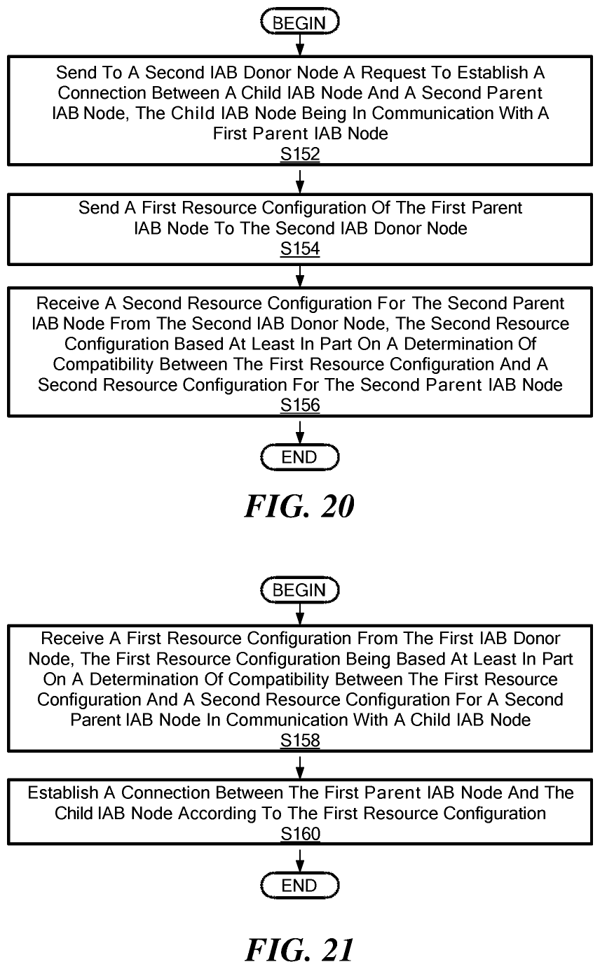

FIG. 20 is a flowchart of an example process in a first IAB donor node 16-1 acting as an F1 terminating IAB donor node for determination of compatible resource configuration in integrated access and backhaul (IAB) migration and topological redundancy. One or more blocks described herein may be performed by one or more elements of first IAB donor node 16-1 such as by one or more of processing circuitry 68 (including the IAB unit 32), processor 70, radio interface 62 and/or communication interface 60. First IAB donor node 16-1 such as via processing circuitry 68 and/or processor 70 and/or radio interface 62 and/or communication interface 60 is configured to send to a second IAB donor node 16-2 a request to establish a connection between an child IAB node 16-5 and a second parent IAB node 16-4, the child IAB node 16-5 being in communication with a first parent IAB node 16-3 (Block S152); send a first resource configuration of the first parent IAB node 16-3 to the second IAB donor node 16-2 (Block S154); and receive a second resource configuration of the second parent IAB node 16-4 from the second IAB donor node 16-2, the second resource configuration based at least in part on a determination of compatibility between the first resource configuration and a second resource configuration for the second parent IAB node 16-4 (Block S156).

According to this aspect, in some embodiments, the processing circuitry 68 is further configured to send a second resource configuration of the first parent IAB node 16-3 to the first parent IAB node 16-3, the second resource configuration based at least in part on the determination of compatibility. In some embodiments, the second IAB donor node 16-2 is in communication with the first IAB donor node 16-1. In some embodiments, the processing circuitry 68 is further configured to receive the second resource configuration of the first parent IAB node 16-3. In some embodiments, the second resource configuration includes an indication of conflicting resources to be deactivated by the network node. In some embodiments, the method includes performing the determination of compatibility between the first resource configuration and the second resource configuration.

FIG. 21 is a flowchart of an example process in a first parent IAB node 16-4 for determination of compatible resource configuration in integrated access and backhaul (IAB) migration and topological redundancy. One or more blocks described herein may be performed by one or more elements of parent IAB node 16-4 such as by one or more of processing circuitry 68 (including the IAB unit 32), processor 70, radio interface 62 and/or communication interface 60. parent IAB node 16-4 such as via processing circuitry 68 and/or processor 70 and/or radio interface 62 and/or communication interface 60 is configured to receive a first resource configuration from a first IAB donor node 16-2, the first resource configuration being based at least in part on a determination of compatibility between the first resource configuration and a second resource configuration for a second parent IAB node 16-3 in communication with an child IAB node 16-5 (Block S158); and establish a connection between the first parent IAB node 16-4 and the child IAB node 16-5 according to the first resource configuration (Block S160).

According to this aspect, in some embodiments, a second IAB donor node 16-1 is in communication with the first IAB donor node 16-2. In some embodiments, the processing circuitry 68 is further configured to maintain a secondary cell group link, the second parent IAB node 16-3 being configured to maintain a master cell group link. In some embodiments, the processing circuitry 68 is further configured to indicate one of a downlink direction and an uplink direction to the child IAB node 16-5 based at least in part on the first resource configuration. In some embodiments, the processing circuitry is further configured to deactivate resources deemed to be conflicting with the second resource configuration of the second parent IAB node 16-3.

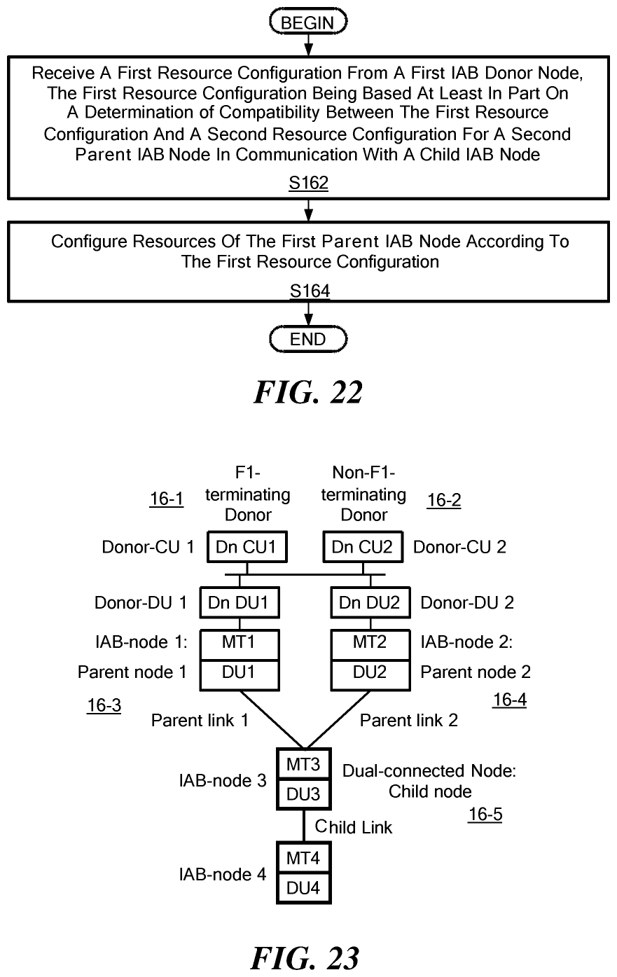

FIG. 22 is a flowchart of an example process in a first parent IAB node 16-3 for determination of compatible resource configuration in integrated access and backhaul (IAB) migration and topological redundancy. One or more blocks described herein may be performed by one or more elements of first parent IAB node 16-3 such as by one or more of processing circuitry 68 (including the IAB unit 32), processor 70, radio interface 62 and/or communication interface 60. First parent IAB node 16-3 such as via processing circuitry 68 and/or processor 70 and/or radio interface 62 and/or communication interface 60 is configured to receive a first resource configuration from a first IAB donor node 16-1, the first resource configuration being based at least in part on a determination of compatibility between the first resource configuration and a second resource configuration for a second parent IAB node 16-4 in communication with an child IAB node (Block S162); and configuring resources of the first parent IAB node 16-3 according to the first resource configuration (Block S164).

In some embodiments, a second IAB donor node 16-2 is in communication with the first IAB donor node 16-1. In some embodiments, the method also includes maintaining a master cell group link, the second parent IAB node 16-4 being configured to maintain a secondary cell group link. In some embodiments, the method includes indicating one of a downlink direction and an uplink direction to the child IAB node 16-5 based at least in part on the first resource configuration. In some embodiments, the method includes deactivating resources deemed to be conflicting with the second resource configuration of the second parent IAB node 16-4.

Having described the general process flow of arrangements of the disclosure and having provided examples of hardware and software arrangements for implementing the processes and functions of the disclosure, the sections below provide details and examples of arrangements for determination of compatible resource configurations in integrated access and backhaul (IAB) migration and topological redundancy.

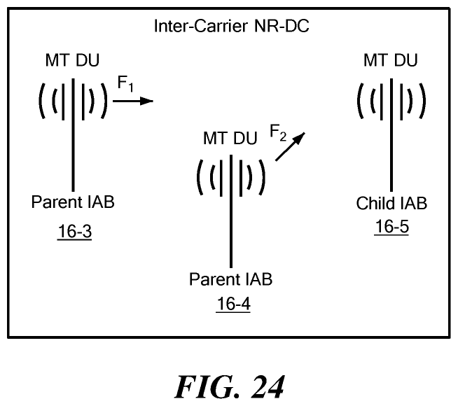

FIG. 23 shows the example of Scenario 2 of FIG. 9 (RAN3) for inter-donor topology redundancy for a dual-connected IAB-node and FIG. 24 is an example diagram of an overview of the example of FIG. 23. In FIG. 23, first and second IAB donor nodes 16-1 and 16-2 are in communication with each other and are in communication with respective first and second parent IAB nodes 16-3 and 16-4. Prior to migration or establishment of dual connectivity, first parent IAB node 16-3 is in communication with an child IAB node 16-5. After migration or establishment of dual connectivity, second parent IAB node 16-4 is in communication with child IAB node 16-5. After migration, the child IAB node 16-5 is no longer in communication with the first parent IAB node 16-3. After dual connectivity establishment, the child IAB node 16-5 is in communication with both the first and second parent IAB nodes 16-3, 16-4.

According to FIG. 23, before establishing dual connectivity, child IAB node 16-5 is a single child node to parent IAB node 16-3 associated to a CU of IAB donor node 16-1. After establishing dual connectivity, IAB child-node 16-5 is a dual-connected child node to parent IAB node 16-3 (first parent-node) associated to the CU of IAB donor node 16-1 (first IAB-donor-CU) and to parent IAB node 16-4 (second parent node) associated to the CU of IAB donor node 16-2 (second IAB-donor-CU).

When operating in standalone (SA)-mode, an NR+NR dual connected IAB-node can add redundant routes by establishing an MCG-link to one parent node IAB-DU and an SCG-link to another parent node IAB-DU. The dual-connecting IAB-MT may enable the SCG link using the 3GPP Rel-15 NR-DC procedures. As described in 3GPP Technical Standard (TS) 37.340, NR+NR dual connectivity is a Multi-Radio Dual Connectivity (MR-DC) configuration with a Fifth Generation core (5GC). In MR-DC, two or more component carriers (CCs) may be aggregated over two cell groups.

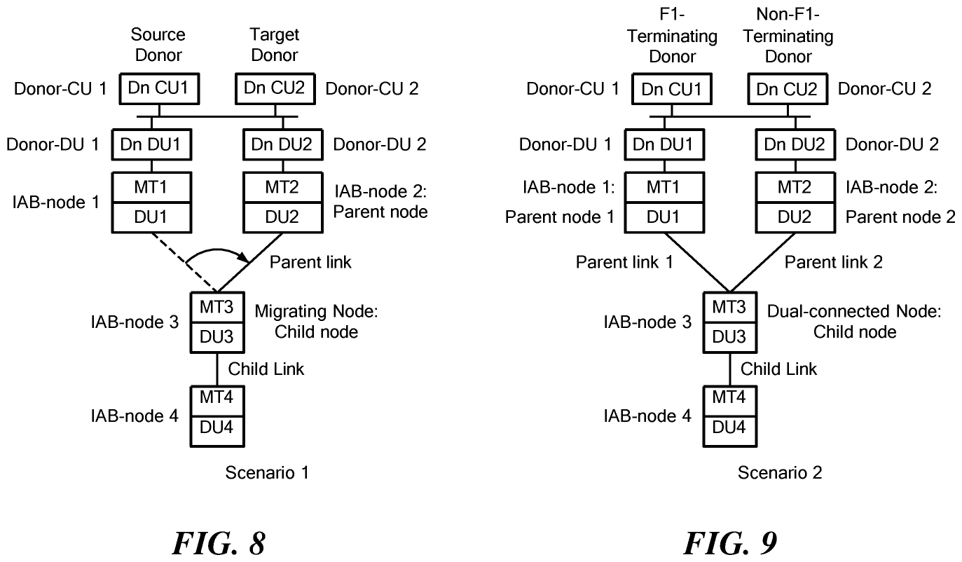

As opposed to Scenario 2 of FIG. 23, where the MT3 of child IAB node 16-5 establishes a second leg, i.e., connects to DU2 of parent IAB node 16-4, in Scenario 1 (IAB migration in FIG. 8), the MT3 of child IAB node 16-5 connects to a new parent DU, i.e., DU2 of parent IAB node 16-4, thus releasing its connection to DU1 of parent IAB node 16-3.

It is noted that the IAB migration scenario (Scenario 1 in FIG. 8) can be considered as a special case of the IAB dual-connectivity scenario (Scenario 2 in FIG. 9). The solutions derived herein for Scenario 2 can be applied to Scenario 1.

Some embodiments apply to IAB-MT using NR-DC to connect to two parents under two different donors, or to an IAB-MT (capable of connecting to only one parent at a time) migrating between two parents under two different donors.

The network function discussed herein is a unit that provides resource configurations to IAB-DU and/or IAB-MT. The network function can be located:
at a node in the radio access network (RAN) (for example an IAB-donor-CU);
as a separate function residing in the core network (for example the Operation, Administration and Management (OAM) function); or
as a virtual node in the cloud (including the above functions).

The terms “network function” and “IAB-donor-CU” are used herein interchangeably.

Some embodiments include methods to evaluate and determine:
for an IAB-node, prior to its migration between two donors, compatible resource configurations between a potential new parent node and the said migrating IAB-node; and
for a dual connectivity-capable IAB-node, before this node establishes the second leg towards a second parent under another donor, compatible resource configurations between two parent links of a dual connected IAB-node.

Scenario 2 (FIG. 23) (i.e., dual connectivity) is a more complicated case in comparison to Scenario 1 (FIG. 8) (i.e., migration of an IAB-node capable of connecting to only one parent), and in particular the solutions derived for Scenario 2 can also be applied to Scenario 1. Hence, in this document only solutions for Scenario 2, are described in detail, i.e., the dual-connectivity scenario of FIG. 23.

For simplicity, solutions are described for the dual connectivity scenario, but the methods can be extended to the multi-parent scenario.

Generally, the resource configuration between the first parent node and the IAB-node may be compatible before the migration procedure or before the DC establishment. Additionally, if the two parent-nodes of a dual connected IAB-node have compatible resource configurations, the resource configurations for the second parent-node may also be compatible with the IAB-node. In case of IAB migration, the evaluation of resource configuration compatibility can for example be performed between the new parent IAB-node and the current parent IAB-node.

An aspect of compatibility can be the alignment and coordinated configuration of a TDD pattern between two IAB-nodes and/or alignment of (TDM/FDM/SDM) H/S/NA resource configurations.

### Operations at the Network Functions

The network functions (e.g., an IAB-donor-CU) are responsible for resource configuration of their served IAB-nodes and parent nodes of these served IAB-nodes, all of these nodes being under the IAB-donor-CU.

During the establishment of inter-donor dual-connectivity, the network function may perform the following example actions:
receiving a first resource configuration (including U/D/F; H/S/NA) related to an IAB-node from its associated IAB-donor-CU (i.e., the IAB-donor-CU currently serving the IAB-node);
determination of compatibility between the first resource configuration and the resource configuration of a second IAB-node; and
based on the determination of compatibility, determining a second resource configuration.

Upon determining that resource compatibility is fulfilled, the network function may perform the following functions:
inform the other (first) donor-CU that the DC establishment request sent by the first donor-CU is accepted;
(optionally) signal an instruction regarding semi-static resource configuration to the second parent-node (i.e., the parent that will serve the secondary DC leg of the IAB-node);
(optionally) signal an instruction regarding semi-static resource configuration to the first parent IAB-node via the IAB-donor-CU of the first parent IAB-node; and
(optionally) signal an instruction regarding the semi-static resource configuration to the IAB-node that is about to become dual-connected, via the first IAB-donor-CU of the first parent IAB-node.

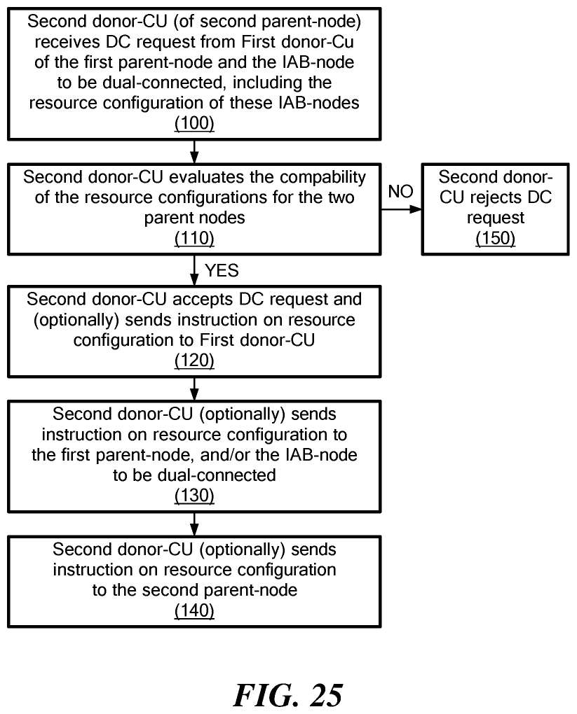

FIG. 25 is a flowchart of an example for a DC scenario. In the first step (100), the second IAB-donor-CU receives a request for establishment of dual-connectivity via the second leg of the DC-capable IAB-node, from the first IAB-donor-CU which is associated to the first parent IAB-node. The first IAB-donor-CU may provide the second IAB-donor-CU with relevant system information of the first parent-node and the IAB-node to be dual-connected, including the semi-static resource configurations (DL/UL/FL, H/S/NA). In the second step (110), the second IAB-donor-CU evaluates the compatibility of the resource of the second parent-node with respect to the resource of the first parent-node. If the compatibility requirement is not fulfilled, the second IAB-donor-CU may reject the DC establishment request (150) from the first IAB-donor-CU.

Upon determining that the compatibility requirement is fulfilled, the second IAB-donor-CU may approve the DC establishment request from the first IAB-donor-CU (120) and optionally send instruction to the first IAB-donor-CU on resource configuration of the first parent-node and the IAB-node to be dual-connected. Upon determining that the compatibility requirement is fulfilled, the first IAB-donor-CU optionally sends instruction on resource configuration to the first parent-node, and/or the IAB-node to be dual-connected (130). Upon determining that the compatibility requirement is fulfilled, the second IAB-donor-CU optionally (140) sends instruction on resource configuration to the second parent-node.

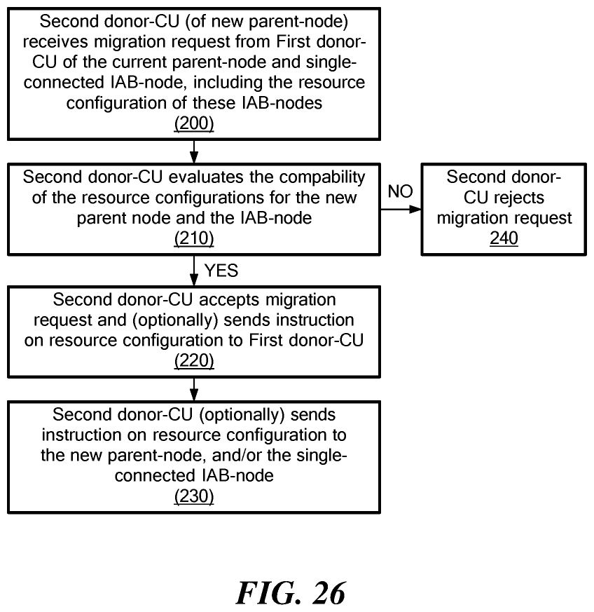

FIG. 26 shows a flow chart of an example for an inter-donor IAB migration scenario. In the first step (200), the second IAB-donor-CU receives a migration request from the first IAB-donor-CU which is associated to the first parent IAB-node. The first IAB-donor-CU may provide the second IAB-donor-CU with relevant system information of the first parent-node and the single-connected IAB-node, including the semi-static resource configurations (DL/UL/FL, H/S/NA). In the second step (210), the second IAB-donor-CU evaluates the compatibility of the resource of the second parent-node with respect to the resource of the first parent-node. If the compatibility requirement is not fulfilled, the second IAB-donor-CU may reject the migration request (240) from the first IAB-donor-CU.

Upon deciding that the compatibility requirement is fulfilled, the second IAB-donor-CU may approve the migration request from the first IAB-donor-CU (220) and optionally sends instruction to the first IAB-donor-CU on resource configuration of the new parent-node and the migrating single-connected IAB-node that these IAB-nodes should apply. Upon deciding that the compatibility requirement is fulfilled, the second IAB-donor-CU optionally (230) sends instruction on resource configuration to the new parent IAB-node and/or the migrating single-connected IAB-node.

Strictly speaking, two resources are compatible if they have identical configuration. However, this is a stringent requirement that may greatly prevent an IAB-node migrating or establishing dual-connectivity to another parent node. Below are two alternative methods which also can ensure compatible resource configurations without providing new resource configurations to the new migrating parent IAB-node, or both parent nodes in dual-connectivity. By allowing some degree of conflict in resource configuration, the requirement on aligned resource configuration is relaxed. In a related embodiment, the second IAB-donor-CU determines resource compatibility based on the ratio of the amount of conflicting resources and to the amount of compatible resources. For example, in one slot of 14 symbols, if conflicting resources and compatible resources are 2 symbols and 12 symbols, respectively, the ratio will be 1/6. As the ratio increases, the second IAB-donor-CU may reject the migration request, or the DC establishment request, since the migration/DC might not be sufficient to provide the desired data throughput. In an alternative embodiment, the second IAB-donor-CU may also reject the migration/DC request based on, for example, the number of served IAB-nodes and WDs.

### Deactivating Conflicting Resources

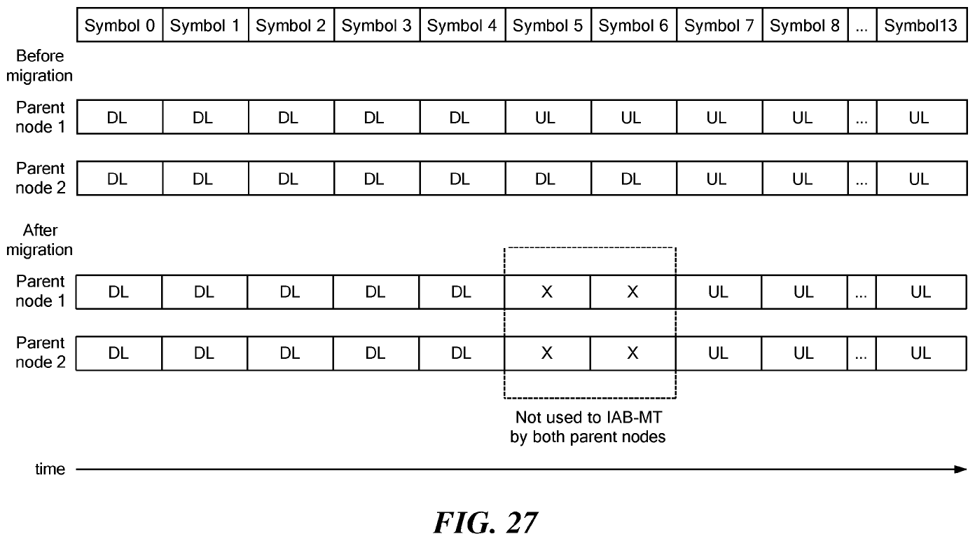

In one embodiment, the compatible resources only allow identical configurations by deactivating resources with conflicting configurations, an example of a conflict being simultaneous indication for transmission by one parent and reception by another parent. In this case, resources which have conflicting configurations between the two parent IAB-nodes are made unavailable to both parent IAB-nodes. One illustrative example is shown in FIG. 27, where the two parent nodes have conflict in Symbol 5 and Symbol 6. Consequently, Symbol 5 and Symbol 6 are made unavailable to both parent IAB-nodes.

In one embodiment, the parent IAB-nodes and the IAB-node to be dual-connected can receive signaling from the associated IAB-donor-CUs to deactivate certain time resources and/or frequency-resources. In a related embodiment, the signaling is an F1 message or a radio resource control (RRC) message or a backhaul adaptation protocol (BAP) message or a medium access control (MAC) control element (CE).

In an alternative embodiment, a method for deactivation is agreed on beforehand. When the migration/DC procedure is completed, the parent IAB-nodes and the IAB-node to be dual-connected may deactivate the overlapping resource without further signaling from the associated IAB-donor-CUs. In this case, the approval of migration/DC serves as an implicit overriding rule for certain configurations of the semi-static resources.

### Prioritization Order

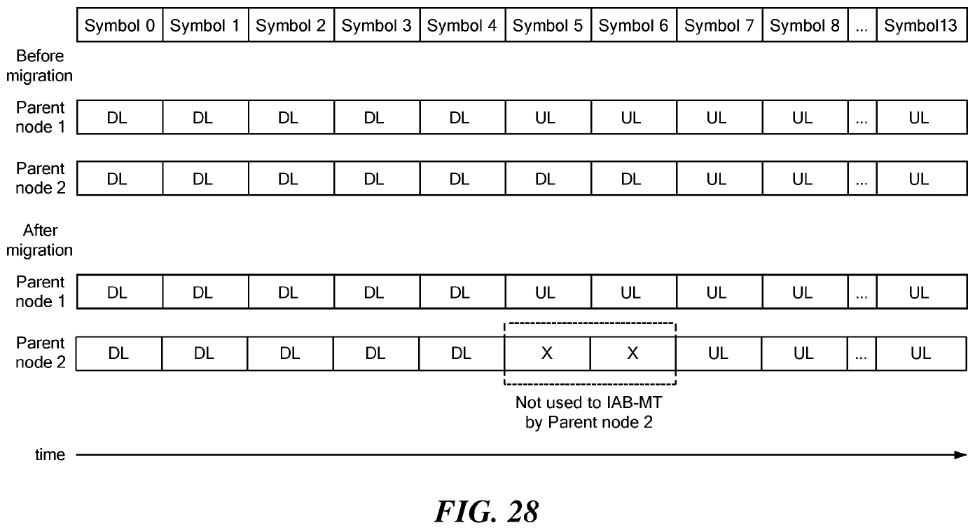

In one embodiment, the compatible resources are achieved by following a prioritization order. In this case, a resource which has a conflict configuration between the two parent IAB-nodes is only available to the prioritized parent IAB-node. One illustrative example is given in FIG. 28, where the two parent nodes have conflicting configurations in Symbol 5 and Symbol 6. As Parent node 1 is prioritized, it can operate according to the original resource configuration. Meanwhile, Symbol 5 and Symbol 6 are not available to Parent node 2. On the other hand, Parent node 2 may use Symbol 5 and Symbol 6 to serve access WDs.

In one embodiment, the second parent IAB-node and IAB-node to be dual-connected can receive signaling from the associated IAB-donor-CUs to deactivate certain time- and/or frequency-resource. In a related embodiment, the signaling is an F1 message or an RRC message or a BAP message or a MAC CE.

In an alternative embodiment, the method for deactivating is agreed on beforehand. When the migration/DC procedure is completed, the de-prioritized parent IAB-node may deactivate the overlapping resource without signaling from the associated IAB-donor-CU. In this case the approval of migration/DC serves as an implicit overriding rule for certain configurations of the semi-static resources.

In an alternative embodiment, resources of the second parent node are prioritized and the resource configuration of the second parent node is not affected.

In an alternative embodiment, the higher priority with respect to using a certain conflicting resource is given to the parent that uses the resource for backhaul, while the conflicting resources used for access, i.e., serving WDs are given lower priority.

In an alternative embodiment, the higher priority with respect to using a certain conflicting resource is given to the parent that uses the resource for control plane traffic, while the conflicting resources used for user plane traffic are given lower priority.

In an alternative embodiment, the parent IAB-nodes, or their respective IAB-donor-CUs on behalf of the parents, negotiate which of the parent IAB-nodes will deactivate a conflicting resource while the other parent IAB-node will keep using it.

### Operations at the First Parent IAB-Node

In some embodiments, when an IAB-node that is connected to a first parent IAB-node begins to establish dual-connectivity to a second leg, the first parent IAB-node may:
Receive its own resource configurations from the IAB-donor-CU;
Provide dynamic indication of the UL/DL direction to the IAB-node to be dual-connected;
(optionally) receive the semi-static resource configuration of the IAB-node; and/or
(optionally) receive instruction on resource configuration from IAB-donor-CU for compatible resource configuration.

After DC establishment, the first parent IAB-node:
(optionally) receives the semi-static resource configuration of the second parent node.

Operations at the second parent IAB-node

When an IAB-node is establishing dual-connectivity to a second parent node, the second parent IAB-node may:
Receive its own resource configurations from the connected IAB-donor-CU; and
(optionally) receive instruction from IAB-donor-CU for compatible resource configuration.

After DC establishment, the second parent IAB-node may:
(optionally) receive the semi-static resource configuration of the dual-connected IAB-node;
(optionally) receive the semi-static resource configuration of the first parent IAB-node; and
Provide dynamic indication of the UL/DL direction to the dual connected IAB-node.

### Operations at the IAB-Node to be Dual-Connected

In some embodiments, when an IAB-node is establishing a second leg to a second parent node in the dual-connectivity mode, the IAB-node may:
Receive semi-static resource configuration from the IAB-donor-CU; and
(optionally) receive instruction from IAB-donor-CU for compatible resource configuration.

Other embodiments may include the following:
In one embodiment, the second parent IAB-node is under control of the same IAB-donor-CU as the first parent IAB-node;
In one embodiment, the first parent node maintains the MCG (Master Cell Group) link and the second parent node maintains the SCG (Secondary Cell Group) link. In an alternative embodiment, the second parent node maintains the MCG link, and the first parent node maintains the SCG link;
In one embodiment, the parent IAB-nodes and the IAB-node to be dual-connected can receive signaling from the associated IAB-donor-CUs to deactivate certain time- and/or frequency-resource. In a related embodiment, the signaling is an F1 message;
In one embodiment, the second IAB-donor-CU can provide the relevant resource information of the second parent IAB-node to the first IAB-donor-CU;
In one embodiment, the first IAB-donor-CU can evaluate the compatibility of the second resource configuration to the first resource configuration and make the migration/DC decision;
In one embodiment, the first IAB-donor-CU can provide a new semi-static resource configuration to the first parent IAB-node, and/or the IAB-node to be dual-connected; and the second IAB-donor-CU can provide a new semi-static resource configuration to the second parent IAB-node; and
In one embodiment, the acceptance of first IAB-donor-CU request for load sharing for one of its congested IAB-nodes by the second IAB-donor-CU is dependent upon the available number of resources (subframes, slots, symbols) left after the resource alignment based upon the new leg (between the link of one of the second IAB-donor-CU's IAB-node and the congested IAB-node from the first IAB-donor-CU) and old leg (between the parent of the congested IAB-node from first IAB-donor-CU and the congested node). The traffic (data volume) that needs to be offloaded from the congested IAB-node (boundary node) to the new parent IAB-node is evaluated against the available number of resources left after resource deactivation as part of resource alignment.

Some embodiments may include the following:

Example 1. A method in a first network node 16 for providing IAB migration/dual-connectivity information about the operation of a second network node 16 to a third network node 16, in order for the second network node 16 to perform as a parent node of the fourth network node 16, the method comprising:
receiving a first resource configuration related to the fourth network node 16 and a network node 16 associated to the fourth network node 16, i.e., the fifth network node 16;
determining a second resource configuration related to the second network node 16 considering the resource configuration related to the fourth network node 16;
determining a resource configuration related to the fifth network node 16 considering the resource configuration related to the fourth network node 16;
determining the resource configuration of the fourth network node 16;
providing a configuration to the second network node 16;
signaling the configuration of the fourth network node 16 to the third network node 16; and
signaling the configuration of the fifth network node 16 to the third network node 16.

Example 2. The method of Example 1, where the first network (NW) node is the IAB-donor-CU serving the second network node 16.

Example 3. The method of Example 1, where the second network node 16 is a potential new parent node to the fourth network node 16. In case of migration, the fourth network node 16 migrates between the fifth network node 16 and the second network node 16. In case of DC, the fourth network node 16 establishes a secondary leg towards the second network node 16.

Example 4. The method of Example 1, where the third network node 16 is the CU of the fourth network node 16.

Example 5. The method of Example 1, where the fifth network node 16 is the master parent node to the fourth network node 16 in case of DC, and the old parent in case of IAB-node migration.

Example 6. Any of the above methods and where the migration/DC information provided is at least one of the following:
decision on the migration request or the dual connectivity establishment request;
resource configuration of the fourth network node 16; and
resource configuration of the fifth network node 16.

Example 7. Any of the above methods and where the migration/DC information provided is at least one of the following:
DL/UL/F slot configuration;
H/S/NA TDM and/or FDM configuration;
TDM/FDM/SDM modes of operation; and
backhaul/access slot configuration.

Example 8. Any of the above methods, further comprising determining at least one IAB-DU resource configuration of the fourth network node 16, based on the at least the two parent node resource configurations (in case of DC the two parents are serving the fourth network node 16, in case of migration, the new parent of the fourth network node 16 is the second network node 16).

Example 9. Any of the above, wherein the second resource configuration is determined to be compatible with the first resource configuration if it is in no symbol or slot configured for a possible transmission when the first configuration indicates a possible reception, and a possible reception when the first configuration indicates a possible transmission

Example 10. Any of the above, wherein the determination of decision on the load balancing request (e.g., via IAB migration request, or IAB DC establishment request, etc.) acceptance is based upon evaluating the traffic that needs to be carried with the available number of UL and DL slots that are remaining after the resource alignment between parent nodes. The resource alignment can be performed by deactivating resources as described above.

According to one aspect, a network node 16 in communication with a first integrated access and backhaul, IAB, donor centralized unit (CU), is provided. The network node 16 includes a radio interface 62 and/or processing circuitry 68 configured to: receive a request for one of migration and establishment of dual connectivity, DC, from the first IAB-donor-CU, the first IAB-donor-CU being associated with a first parent IAB-node connected to a DC-capable child IAB-node, the request including a resource configuration of the first parent IAB-node. The network node 16, radio interface 62 and processing circuitry 68 are also configured to evaluate a compatibility of the resource configuration of the first parent IAB-node with a resource configuration of a second parent IAB-node connected to the DC-capable child IAB-node, the second IAB-donor-CU being associated with the second parent IAB-node. The request is one of accepted and rejected based at least in part on the compatibility evaluation.

According to this aspect, in some embodiments, the network node 16, radio interface 62 and/or comprising circuitry are configured to send instructions to the second IAB-donor-CU to reconfigure resources of the second parent node and the DC-capable child IAB-node, when the compatibility evaluation results in acceptance of the request. In some embodiments, the network node 16, radio interface 62 and/or comprising circuitry are further configured to send instructions to the IAB-donor-CU to reconfigure resources of the second parent node only, when the compatibility evaluation results in acceptance of the request. In some embodiments, the compatibility evaluation includes evaluation of a ratio of an amount of conflicting resources to an amount of compatible resources of the first and second parent IAB-nodes. In some embodiments, the network node 16, radio interface 62 and/or processing circuitry 68 are further configured to deactivate resources of at least one of the first and second IAB nodes when the compatibility evaluation indicates conflicting resource configurations between the first and second parent IAB-nodes.

According to another aspect, a method implemented in a network node 16 in communication with a first integrated access and backhaul, IAB, donor centralized unit (CU) is provided. The method includes receiving a request for one of migration and establishment of dual connectivity, DC, from the first IAB-donor-CU, the first IAB-donor-CU being associated with a first parent IAB-node connected to a DC-capable child IAB-node, the request including a resource configuration of the first parent IAB-node. The method also includes evaluating a compatibility of the resource configuration of the first parent IAB-node with a resource configuration of a second parent IAB-node connected to the DC-capable child IAB-node, the second IAB-donor-CU being associated with the second parent IAB-node. The method further includes one of accepting the request and rejecting the request based at least in part on the compatibility evaluation.

According to this aspect, in some embodiments, the method also includes, sending instructions to the second IAB-donor-CU to reconfigure resources of the second parent node and the DC-capable child IAB-node, when the compatibility evaluation results in acceptance of the request. In some embodiments, the method also includes sending instructions to the IAB-donor-CU to reconfigure resources of the second parent node only, when the compatibility evaluation results in acceptance of the request. In some embodiments, the compatibility evaluation includes evaluation of a ratio of an amount of conflicting resources to an amount of compatible resources of the first and second parent IAB-nodes. In some embodiments, the method also includes deactivating resources of at least one of the first and second IAB nodes when the compatibility evaluation indicates conflicting resource configurations between the first and second parent IAB-nodes.

According to yet another aspect, a network node 16 operating as a parent integrated access and backhaul, IAB, node to a dual connectivity (DC)-capable child IAB-node is provided. The network node 16 is in communication with a first IAB-donor-centralized unit (CU). The network node 16 includes a radio interface 62 and/or processing circuitry 68 configured to: obtain a resource configuration from the first IAB-donor-CU, the resource configuration being selected according to an evaluation of compatibility between resources of the network node 16 and the DC-capable child IAB-node; and indicate a transmission direction to a DC-capable child IAB-node that seeks one of migration and dual connectivity.

According to this aspect, in some embodiments, the network node 16, radio interface 62, and/or processing circuitry 68 are further configured to configure resources of the DC-capable child IAB-node according to instructions from the first IAB-donor-CU. In some embodiments, the network node 16, radio interface 62 and/or processing circuitry 68 are further configured to configure resources of the network node 16 according to instructions from the first IAB-donor-CU. In some embodiments, the network node 16, radio interface 62 and/or processing circuitry 68 are further configured to receive a resource configuration of a second parent IAB-node.

According to another aspect, a method implemented in a network node 16 operating as a parent integrated access and backhaul, IAB, node to a dual connectivity (DC)-capable child IAB-node, the network node 16 in communication with a first IAB-donor-centralized unit (CU), is provided. The method includes obtaining a resource configuration from the first IAB-donor-CU, the resource configuration being selected according to an evaluation of compatibility between resources of the network node 16 and the DC-capable child IAB-node; and indicating a transmission direction to a dual connectivity (DC)-capable child IAB-node that seeks one of migration and dual connectivity.

According to this aspect, in some embodiments, the method further includes configuring resources of the DC-capable child IAB-node according to instructions from the first IAB-donor-CU. In some embodiments, the method also includes configuring resources of the network node 16 according to instructions from the first IAB-donor-CU. In some embodiments, the method also includes receiving a resource configuration of a second parent IAB-node.

According to yet another aspect, a network node 16 operating as a dual connectivity (DC)-capable child integrated access and backhaul, IAB, node is provided. The network node 16 may be in communication with a first parent IAB-node operating under instructions from an IAB-donor-centralized unit (CU). The network node 16 includes a radio interface 62 and/or processing circuitry 68 configured to: receive a resource configuration from the IAB-donor-CU via the first parent IAB-node, the resource configuration being selected according to an evaluation of compatibility between resources of the network node 16 and the first parent IAB-node.

According to another aspect, a method is provided in a network node 16 operating as a dual connectivity (DC)-capable child integrated access and backhaul, IAB, node, the network node 16 in communication with a first parent IAB-node operating under instructions from an IAB-donor-centralized unit (CU). The method includes receiving a resource configuration from the IAB-donor-CU via the first parent IAB-node, the resource configuration being selected according to an evaluation of compatibility between resources of the network node 16 and the first parent IAB-node.

Some embodiments may include one or more of the following:

Embodiment A1. A network node in communication with a first integrated access and backhaul, IAB, donor centralized unit (CU), the network node configured to, and/or comprising a radio interface and/or comprising processing circuitry configured to:
receive a request for one of migration and establishment of dual connectivity, DC, from the first IAB-donor-CU, the first IAB-donor-CU being associated with a first parent IAB-node connected to a DC-capable child IAB-node, the request including a resource configuration of the first parent IAB-node;
evaluate a compatibility of the resource configuration of the first parent IAB-node with a resource configuration of a second parent IAB-node connected to the DC-capable child IAB-node; and
one of accept the request and reject the request based at least in part on the compatibility evaluation.

Embodiment A2. The network node of Embodiment A1, wherein the network node, radio interface and/or comprising circuitry are configured to send instructions to the first IAB-donor-CU to reconfigure resources of the second parent IAB-node and the DC-capable child IAB-node, when the compatibility evaluation results in acceptance of the request.

Embodiment A3. The network node of Embodiment A1, wherein the network node, radio interface and/or comprising circuitry are further configured to send instructions to the first IAB-donor-CU to reconfigure resources of the second parent IAB-node only, when the compatibility evaluation results in acceptance of the request.

Embodiment A4. The network node of any of Embodiments A1-A3, wherein the compatibility evaluation includes evaluation of a ratio of an amount of conflicting resources to an amount of compatible resources of the first and second parent IAB-nodes.

Embodiment A5. The network node of any of Embodiments A1-A4, wherein the network node, radio interface and/or processing circuitry are further configured to deactivate resources of at least one of the first and second parent IAB nodes when the compatibility evaluation indicates conflicting resource configurations between the first and second parent IAB-nodes.

Embodiment B1. A method implemented in a network node in communication with a first integrated access and backhaul, IAB, donor centralized unit (CU), the method comprising:
receiving a request for one of migration and establishment of dual connectivity, DC, from the first IAB-donor-CU, the first IAB-donor-CU being associated with a first parent IAB-node connected to a DC-capable child IAB-node, the request including a resource configuration of the first parent IAB-node;
evaluating a compatibility of the resource configuration of the first parent IAB-node with a resource configuration of a second parent IAB-node connected to the DC-capable child IAB-node; and
one of accepting the request and rejecting the request based at least in part on the compatibility evaluation.

Embodiment B2. The method of Embodiment B1, further comprising sending instructions to the first IAB-donor-CU to reconfigure resources of the second parent IAB-node and the DC-capable child IAB-node, when the compatibility evaluation results in acceptance of the request.

Embodiment B3. The method of Embodiment B1, further comprising sending instructions to the first IAB-donor-CU to reconfigure resources of the second parent IAB-node only, when the compatibility evaluation results in acceptance of the request.

Embodiment B4. The method of any of Embodiments B1-B3, wherein the compatibility evaluation includes evaluation of a ratio of an amount of conflicting resources to an amount of compatible resources of the first and second parent IAB-nodes.

Embodiment B5. The method of any of Embodiments B1-B4, further comprising deactivating resources of at least one of the first and second parent IAB nodes when the compatibility evaluation indicates conflicting resource configurations between the first and second parent IAB-nodes.

Embodiment C1. A network node operating as a parent integrated access and backhaul, IAB, node to a dual connectivity (DC)-capable child IAB-node, the network node in communication with a first IAB-donor-centralized unit (CU), the network node configured to, and/or comprising a radio interface and/or comprising processing circuitry configured to: obtain a resource configuration from the first IAB-donor-CU, the resource configuration being selected according to an evaluation of compatibility between resources of the network node and the DC-capable child IAB-node; and indicate a transmission direction to a DC-capable child IAB-node that seeks one of migration and dual connectivity.

Embodiment C2. The network node of Embodiment C1, wherein the network node, radio interface, and/or processing circuitry are further configured to configure resources of the DC-capable child IAB-node according to instructions from the first IAB-donor-CU.

Embodiment C3. The network node of any of Embodiments C1 and C2, wherein the network node, radio interface and/or processing circuitry are further configured to configure resources of the network node according to instructions from the first IAB-donor-CU.

Embodiment C4. The network node of any of Embodiments C₁-C₃, wherein the network node, radio interface and/or processing circuitry are further configured to receive a resource configuration of a second parent IAB-node.

Embodiment D1. A method implemented in a network node operating as a parent integrated access and backhaul, IAB, node to a dual connectivity (DC)-capable child IAB-node, the network node in communication with a first IAB-donor-centralized unit (CU), the method comprising:
obtaining a resource configuration from the first IAB-donor-CU, the resource configuration being selected according to an evaluation of compatibility between resources of the network node and the DC-capable child IAB-node; and
indicating a transmission direction to a dual connectivity (DC)-capable child IAB-node that seeks one of migration and dual connectivity.

Embodiment D2. The method of Embodiment D1, further comprising configuring resources of the DC-capable child IAB-node according to instructions from the first IAB-donor-CU.

Embodiment D3. The method of any of Embodiments D1 and D2, further comprising configuring resources of the network node according to instructions from the first IAB-donor-CU.

Embodiment D4. The method of any of Embodiments D1-D3, further comprising receiving a resource configuration of a second parent IAB-node.

Embodiment E1. A network node operating as a dual connectivity (DC)-capable child integrated access and backhaul, IAB, node, the network node in communication with a first parent IAB-node operating under instructions from an IAB-donor-centralized unit (CU), the network node configured to, and/or comprising a radio interface and/or comprising processing circuitry configured to:
receive a resource configuration from the IAB-donor-CU via the first parent IAB-node, the resource configuration being selected according to an evaluation of compatibility between resources of the network node and the first parent IAB-node.

Embodiment F1. A method in a network node operating as a dual connectivity (DC)-capable child integrated access and backhaul, IAB, node, the network node in communication with a first parent IAB-node operating under instructions from an IAB-donor-centralized unit (CU), the method comprising:
receiving a resource configuration from the IAB-donor-CU via the first parent IAB-node, the resource configuration being selected according to an evaluation of compatibility between resources of the network node and the first parent IAB-node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first integrated access and backhaul, IAB, donor node, the first IAB donor node including processing circuitry configured to:
receive a first resource configuration for a first parent IAB node from a second IAB donor node, the first parent IAB node being in communication with a child IAB node;
determine compatibility between the first resource configuration and a second resource configuration for a second parent IAB node; and
determine whether to accept a request to establish a connection between the second parent IAB node and the child IAB node based at least in part on the compatibility determination.

2. The first IAB donor node of claim 1, wherein, when it is determined that there is a compatibility between the first and second resource configurations, the processing circuitry is further configured to configure the second parent IAB node with the second resource configuration.

3. The first IAB donor node of claim 1, wherein, when it is determined that there is a compatibility between the first and second resource configurations, the processing circuitry is further configured to send the second resource configuration to the second IAB donor node.

4. The first IAB donor node of claim 1, wherein determining compatibility between the first and second resource configurations is based at least in part on a ratio of an amount of conflicting resources to an amount of compatible resources between the first and second resource configurations.

5. The first IAB donor node of claim 1, wherein the processing circuitry is further configured to determine conflicting resources between the first and second resource configurations and to deactivate the conflicting resources for at least one of the first parent IAB node and the second parent IAB node.

6. The first IAB donor node of claim 1, wherein determining compatibility between the first and second resource configurations is based at least in part on a priority associated with each of the first and second parent IAB nodes.

7. The first IAB donor node of claim 1, wherein the processing circuitry is further configured to determine whether to accept the request to establish the connection based at least in part on an amount of congestion in one of the first and second parent IAB nodes.

8. A method in a first integrated access and backhaul, IAB, donor node, the method comprising:
receiving a first resource configuration for the first parent IAB node from a second IAB donor node, the first parent IAB node being in communication with a child IAB node;
determining compatibility between the first resource configuration and a second resource configuration for a second parent IAB node; and
determining whether to accept a request to establish a connection between the second parent IAB node and the child IAB node based at least in part on the compatibility determination.

9. The method of claim 8, further comprising, when it is determined that there is a compatibility between the first and second resource configurations, configuring the second parent IAB node with the second resource configuration.

10. The method of claim 8, further comprising, when it is determined that there is a compatibility between the first and second resource configurations, sending the second resource configuration to the second IAB donor node.

11. The method of claim 8, wherein determining compatibility between the first and second resource configurations is based at least in part on a ratio of an amount of conflicting resources to an amount of compatible resources between the first and second resource configurations.

12. The method of claim 8, further comprising determining conflicting resources between the first and second resource configurations and to deactivate the conflicting resources for at least one of the first parent IAB node and the second parent IAB node.

13. The method of claim 8, wherein determining compatibility between the first and second resource configurations is based at least in part on a priority associated with each of the first and second parent IAB nodes.

14. The method of claim 8, further comprising determining whether to accept the request to establish the connection based at least in part on an amount of congestion in one of the first and second parent IAB nodes.

15. A first integrated access and backhaul, IAB, donor node the first IAB donor node comprising processing circuitry configured to:
send to a second IAB donor node a request to establish a connection between a child IAB node and a second parent IAB node, the child IAB node being in communication with a first parent IAB node;
send a first resource configuration of the first parent IAB node to the second IAB donor node; and
receive a second resource configuration for the second parent IAB node from the second IAB donor node, the second resource configuration based at least in part on a determination of compatibility between the first resource configuration and a second resource configuration for the second parent IAB node.

16. The first IAB donor node of claim 15, wherein the processing circuitry is further configured to send a second resource configuration of the first parent IAB node to the first parent IAB node, the second resource configuration based at least in part on the determination of compatibility.

17. The first IAB donor node of claim 15, wherein the processing circuitry is further configured to receive the second resource configuration of the first parent IAB node.

18. The first IAB donor node of claim 15, wherein the second resource configuration includes an indication of conflicting resources to be deactivated by the first IAB donor node.

19. The first IAB donor node of claim 15, wherein the processing circuitry is further configured to perform the determination of compatibility between the first resource configuration and the second resource configuration.

20.-44. (canceled)
